(19) United States
(12) Patent Application Publication
(10) Pub. No.: US 2003/0204116 A1
(43) Pub. Date: Oct. 30, 2003

(54) Process for the production of phosphonium phenolates

(76) Inventors: Melanie Mothrath, Dusseldorf (DE); Lothar Bunzel, Kempen (DE); Silke Kratschmer, Frankfurt (DE)

Correspondence Address: BAYER POLYMERS LLC, 100 BAYER ROAD, PITTSBURGH, PA, 15205, US

(21) Appl. No.: 10/420,400

(22) Filed: Apr. 22, 2003

(30) Foreign Application Priority Data
Apr. 29, 2002 (DE) 10219027.5

(51) Int. Cl. C07F 9/02; C08G 64/00

(52) U.S. Cl. 568/9; 528/198

(57) ABSTRACT

A process for producing a high purity tetraphenylphosphonium phenolate that at room temperature is in liquid form is disclosed. The process entails (i) reacting tetraphenylphosphonium halide with phenol in an aqueous-alkaline solution at temperatures of up to 55° C., at a molar ratio of phenol to tetraphenylphosphonium halide ≧10:1 and at pH values of 9.5 to 11 to obtain a material system containing an organic phase and an aqueous phase and, (ii) upon completion of the reaction adding a solution of water and a sparingly soluble alcohol to separate the aqueous phase from the organic phase. The phosphonium phenolate thus produced is suitable as transesterification catalyst, in particular for solvent-free production of thermoplastic polycarbonate.

### FIELD OF THE INVENTION

The present invention is directed to phosphonium phenolates and more particular to a liquid form thereof and to its use as a catalyst in the transesterification process for making polycarbonates.

### SUMMARY OF THE INVENTION

A process for producing a high purity tetraphenylphosphonium phenolate that at room temperature is in liquid form is disclosed. The process entails (i) reacting tetraphenylphosphonium halide with phenol in an aqueous-alkaline solution at temperatures of up to 55° C., at a molar ratio of phenol to tetraphenylphosphonium halide ≧10:1 and at pH values of 9.5 to 11 to obtain a material system containing an organic phase and an aqueous phase and, (ii) upon completion of the reaction adding a solution of water and a sparingly soluble alcohol to separate the aqueous phase from the organic phase. The phosphonium phenolate thus produced is suitable as transesterification catalyst, in particular for solvent-free production of thermoplastic polycarbonate.

### BACKGROUND OF THE INVENTION

The production of phosphonium phenolates is known from DE-A-197 273 51 and WO 01/46100 A1. Said documents describe processes for the synthesis of high purity phosphonium phenolates which are obtained in crystalline form as phenol adducts. Once dissolved in phenol at temperatures in excess of 45° C., the phenol adducts of phosphonium phenolates obtained in said manner are used on a large industrial scale as transesterification catalysts in melt transesterification processes for the production of polycarbonate.

If the phenol adducts of phosphonium phenolates are to be used as transesterification catalysts in melt transesterification processes, catalyst purity is of vital significance as impurities may result in variations in activity, discoloration or secondary reactions in the transesterification process. DE-A-199 107 45 discloses a formulation of tetraphenylphosphonium phenolate (TPP-P) with phenol which is liquid at room temperature and has a composition of 28 to 45 wt. % of TPP-P in phenol. This makes it possible to add the catalyst in the liquid state without prior exposure to elevated temperatures and without foreign substances and additives. The liquid formulation is produced by blending the high purity, crystalline phenol adducts of TPP-P obtainable according to DE-A-197 273 51 and WO 01/4600 A1 with appropriate quantities of phenol in order to ensure the purity of the resultant formulation. On a large industrial scale, however, direct addition of the catalyst formulation which is liquid at room temperature and is obtainable in said manner is not feasible in a continuous melt transesterification process for the production of polycarbonate due to the elevated catalyst concentrations. Further dilution with phenol is required, which, overall, makes this method extremely troublesome. Moreover, it is difficult on a large scale to maintain during the various mixing and dilution steps the inert conditions which ensure consistent catalyst quality.

However, packaging and storage advantages would be achieved if it were possible straightforwardly and directly to synthesise the catalyst formulations, liquid at room temperature, of TPP-P which are described in DE 198 10 745 A1. Phenol adducts of phosphonium phenolates are in fact generally produced in separate facilities which are physically remote from the transesterification process. This entails storage of the catalyst prior to use. In order to maintain constantly high catalyst quality during storage, a simple process, which suppresses the greatest possible number of external influences, for packaging the catalysts in an inert, opaque container after production of the catalyst is thus desirable. A liquid catalyst formulation would be advantageous in this connection. The catalyst should simultaneously have the smallest possible surface area and it should be possible straightforwardly to introduce it into the melt process under inert conditions. With regard to the production of high purity polycarbonate for optical applications using the melt transesterification process, it would furthermore be advantageous to be able to remove ultrafine particles from the catalyst by filtration. These problems too may readily be solved with a liquid catalyst formulation.

The object of the present invention is accordingly to provide a process by means of which it is straightforwardly possible directly to produce a formulation of tetraphenylphosphonium phenolate with phenol which is liquid at room temperature and which yields phosphonium phenolate of the highest possible purity.

### DETAILED DESCRIPTION OF THE INVENTION

It has surprisingly now been found that it is possible directly to produce high purity formulations of tetraphenylphosphonium phenolate with phenol which are liquid at room temperature by reaction of phosphonium halides and phenols in an aqueous-alkaline solution.

The present invention accordingly provides a process for the direct production of high purity formulations of tetraphenylphosphonium phenolate with phenol which are liquid at room temperature from tetraphenylphosphonium halides and phenol in an aqueous-alkaline solution at temperatures of 0 to 550° C., which process is characterized in that the reaction is performed at a molar ratio of phenol to tetraphenylphosphonium halide of ≧10:1 and at pH values of 9.5 to 11 and, after the reaction, sparingly soluble alcohols are added in ratios by weight of the aqueous reaction solution to alcohol of between 2:1 to 1:2, wherein the alcohols have a solubility in pure water of <20 wt. %, preferably of <15 wt. %.

The reaction is preferably performed at temperatures of 0 to 55° C., in particular of 15 to 50° C.

The reaction is preferably performed at molar ratios of phenol to phosphonium halide of ≧10:1, particularly preferably of 10:1 to 13:1.

The reaction is preferably performed at pH values of 9.5 to 11.

After the reaction, sparingly soluble alcohols are added in quantities of 50 wt. % to 200 wt. %, preferably of 55 wt. % to 140 wt. %, relative to the quantity by weight of aqueous reaction solution, wherein the alcohols preferably have a solubility in pure water of <20 wt. %, preferably of <15 wt. %.

The liquid formulation of tetraphenylphosphonium phenolate produced said manner contains no more than 0.3 wt. %, preferably 0.1 wt. % of halide.

The liquid formulation of tetraphenylphosphonium phenolate produced said manner contains no more than 1 ppm, preferably 0.5 ppm of alkaline sodium compounds.

Tetraphenylphosphonium halides of the formula (I) are in particular used for the reaction

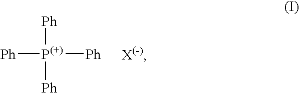

in which

X⁽⁻⁾ denotes a halide ion, preferably F⁽⁻⁾, Cl⁽⁻⁾ or Br⁽⁻⁾.

The formula (I) preferably describes tetraphenylphosphonium bromide.

Such tetraphenylphosphonium halides and the production thereof are known or obtainable using known methods (see for example “Houben-Weyl, Methoden der organischen Chemie” volume XII/1, pages 79 et seq. and Worrall, J. Amer. Chem. Soc. 52 (1930), pages 293 et seq.).

These compounds (I) are obtained on reaction of triphenyl phosphine with haloaryls or haloalkyls, for example benzyl bromide, in the presence of metal salts (Friedel-Crafts alkylation) or in the presence of Grignard compounds and cobalt(II) chloride.

Phenols preferred for the reaction are phenol or substituted phenols as well as bisphenols.

Particularly preferred phenols are those of the formula (II)

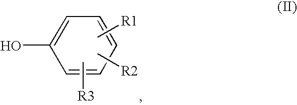

in which

R₁ to R₃ mutually independently denote H. C₁-C₁₂ alkyl, C₅-C₆ cycloalkyl, C₇-C₁₂ arylalkyl and C₆-C₁₄ aryl; R₁ to R₃ preferably denote hydrogen.

Such phenols are known from the literature.

Tetraphenylphosphonium phenolates of the formula (III) are preferably produced

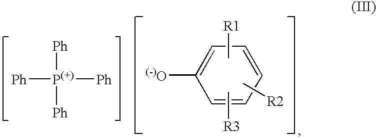

in which R₁ to R₃ have the above-stated meanings.

Deionised or distilled water is preferably used to produce the aqueous-alkaline phase.

The pH value of 9.5 to 11.0 is preferably established with the assistance of an alkali metal hydroxide solution, preferably sodium hydroxide solution or potassium hydroxide solution, while taking account of the buffering action of phenol/Na phenolate.

The process according to the invention may be performed continuously or discontinuously, with discontinuous operation being preferred.

According to a preferred method, phenol, tetraphenylphosphonium halide and water are initially introduced into a vessel as a solution at 40° C. With optional cooling, the pH value is adjusted to values of 9.5 to 11.0 with addition of alkali metal hydroxide solution. The reaction components are here maintained, preferably with vigorous stirring, at a temperature of 0 to 55° C., preferably of 10 to 50° C. The reaction should last less than 2 hours, preferably less than 1 hour.

After the reaction, an alcohol sparingly soluble in water is added to the aqueous reaction solution in a quantity such that the aqueous phase separates from the organic phase and the latter is extracted at least once, preferably 5 times with deionised or distilled water. Sparingly soluble alcohols should be taken to be those having a solubility in water of <20 wt. %, preferably of <15 wt. %. The alcohol is subsequently removed from the separated organic phase by vacuum distillation, such that a colourless formulation of tetraphenylphosphonium phenolate which is liquid at room temperature is retained.

Alcohols which are suitable according to the invention for the reaction solution are aliphatic alcohols of the formula CₙH₂ₙ₊₁—OH, in which n is an integer from 4 to 10 inclusive, such as for example n-propanol, isopropanol, n-butanol, isobutanol, n-pentanol, methylbutanols, neopentanol, amyl alcohols, branched and unbranched hexanols, heptanols, octanols, nonanols or decanols.

Alcohols which are suitable according to the invention for the reaction solution are also cycloaliphatic alcohols of the formula CₙH₂ₙ₋₁—OH, in which n is an integer from 5 to 10 inclusive, such as for example cyclopentanol, methylcyclopentanols, cyclopentanemethanol, cyclopentylpropanols, cyclohexanol, cyclohexylethanols, cyclohexylpropanols, cyclohexylbutanols, methyl-, ethyl-, propyl- and butylhexanols, cycloheptanols, cyclooctanols.

Polyhydric aliphatic or cycloaliphatic alcohols may also be used according to the invention.

Preferred aliphatic alcohols are propanols, (iso)butanols, pentanols and hexanols, in particular isobutanol and isopropanol.

Preferred cycloaliphatic alcohols are cyclopentanol, cycloheptanol and cyclooctanol, particularly preferably cyclohexanol.

After addition of the alcohol, once the reaction to yield the phosphonium phenolate is complete, the ratio by weight of water to alcohol is between 2:1 and 1:2, preferably between 1:1 and 1:2.

The alcohols to be used according to the invention are added to enhance working-up, as the phenol/alcohol mixture has a lower density than the aqueous solution and the organic phase thus lies above the aqueous phase. The aqueous phase may accordingly be drained off from beneath, while the organic phase, which contains the phenolate, may be washed with deionised water in the same separation vessel and the washing water may then in turn be drained off from beneath.

If the alcohol is not added, only the salt-containing aqueous solution is heavier than the organic phase and can be drained off from beneath. On subsequent washing with deionised water, phase inversion occurs, the organic phase being heavier and thus beneath the aqueous phase. This working-up method is thus more complex in that a second working-up vessel is required.

Quaternary phosphonium phenolates produced according to the invention are in particular compounds of the formulae

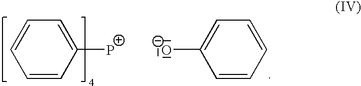

Using the process according to the invention, it is possible to produce a formulation of tetraphenylphosphonium phenolate which is liquid at room temperature at high yield and elevated purity.

Once isolated, the resultant formulation, liquid at room temperature, of tetraphenylphosphonium phenolate or other phosphonium phenolates is packaged under inert conditions in an inert, opaque storage container, provided with a blanket of nitrogen or other inert gases and sealed.

The formulation, liquid at room temperature, of tetraphenylphosphonium phenolate is stored in liquid form in sealed containers at temperatures of 0 to 40° C., preferably of 5 to 35° C. for a period of up to 5 years, preferably of up to 3 years.

The liquid formulation of tetraphenylphosphonium phenolate produced and stored in said manner is particularly suitable as an esterification and transesterification catalyst, in particular for the production of polycarbonates using the melt transesterification process (c.f. U.S. Pat. No. 3, 442,854).

As is known, the melt transesterification process starts, for example, from aromatic diphenols, carbonic acid diaryl esters and optionally branching agents and/or monophenols.

The liquid formulation of tetraphenylphosphonium phenolate obtainable according to the invention is in this case used as a catalyst in quantities of 10⁻¹ mol to 10⁻⁸ mol, preferably in quantities of 10⁻³ mol to 10⁻⁷ mol, per mol of diphenol.

In an alternative method, the liquid formulation of tetraphenylphosphonium phenolate obtainable according to the invention is filtered prior to use as a catalyst in the melt transesterification process, filtration preferably proceeding in two stages. The filter for the second stage has an absolute pore size of 3 μ, preferably of 1 μ, most preferably of 0.5 μ.

Further details of the melt transesterification process are described in the literature (c.f. for example Hermann Schnell, Chemistry and Physics of Polycarbonates, Polymer Reviews, Vol. 9, 1964, pages 44 to 51, DE-A 1 031 512, U.S. Pat. Nos. 3,022,272, 5,340,905 and U.S. Pat. No. 5,399,659).

Thermoplastic polycarbonates produced using the liquid formulation of tetraphenylphosphonium phenolate obtainable according to the invention are solvent-free, have a light intrinsic colour and are largely free of unwanted defects in the polycarbonate.

The polycarbonates produced in this manner may be used industrially in the form of the most varied mouldings in any applications in which thermoplastic polycarbonates have previously been used, for example in electrical engineering, as lamp shrouds, as safety glazing or as optical data storage media, for example CD material.

The invention is further illustrated but is not intended to be limited by the following examples in which all parts and percentages are by weight unless otherwise specified.

### EXAMPLES

The following Examples are intended to illustrate the invention, but without restricting its scope.

A ³¹P-NMR spectrum is recorded to identify tetraphenylphosphonium phenolate. To this end, the substance is dissolved in deuterated chloroform and analysed.

The content of tetraphenylphosphonium cations and phenol/phenolate is determined by means of ¹³C-NMR. To this end, a spectrum is recorded, the signals for tetraphenylphosphonium cations and phenol/phenolate are integrated and, normalized to 100%, stated as mol percentages.

The phosphorus content is determined by heating a weighed quantity of sample with nitric acid and then dissolving it in sulfuric and perchloric acid. The resultant phosphoric acid is precipitated with ammonium molybdate. The precipitate is collected in a filtering crucible and the phosphorus content is determined by weighing.

The bromine content is determined by combusting a weighed quantity of the substance in a Wickbold apparatus and absorbing the combustion gases. The bromide content is determined from this solution by means of ion exchange chromatography.

The sodium content is determined by atomic absorption spectroscopy and ICP.

Karl-Fischer water content is determined to ISO 760 (Determination of Water-Karl Fischer Method, 1st ed., 1978-12-01).

The color value was determined as the difference in absorbance at 420 nm and 700 nm in dichloromethane at a concentration of 2.4 g/50 ml and a pathlength of 10 cm.

The relative solution viscosity was determined in dichloromethane at a concentration of 5 g/l and 25° C.

The content of phenolic OH is obtained by IR measurement. To this end, a differential measurement is performed of a solution of 2 g of polymer in 50 ml of dichloromethane relative to pure dichloromethane and the difference in absorbance determined at 3582 cm⁻¹.

### Comparative Example 1

A formulation of tetraphenylphosphonium phenolate which is liquid at room temperature is produced according to WO 01/46100 and DE 198 10 745 A1.

376 g (4.0 mol) of phenol, 800 ml of deionised water, 335.44 g (0.8 mol) of tetraphenylphosphonium bromide and 640 g of isobutanol are initially introduced into a 2 L round-bottomed flask fitted with a stirrer, thermometer and dropping funnel and stirred at 20° C. to 25° C. 79 g (0.97 mol) of 49% sodium hydroxide solution are added dropwise within approx. 5 minutes, the pH value is adjusted to a range from 9.5 to 11.0. The mixture is then stirred for 0.5 h at 45° C. Once the phases have separated, the lower, aqueous phase is drained off and the organic phase washed three times with deionised water, with the washing water as the heavier phase in each case being drained off from beneath. The organic phase is then cooled to room temperature while being stirred, the product crystallising out. After crystallising for at least 4 hours, the product is removed by suction filtration. After NMR analysis for content of phenol, isobutanol and tetraphenylphosphonium phenolate, the filtrate is returned to the reaction. The crystalline residue is rewashed with 2-propanol and dried at 100° C. under a water-jet vacuum.

A crystalline product with a TPP-P content of 64.4 wt. % and a phenol content of 35.5 wt. % is obtained. The water content is below 0.05%, the bromine content below 0.01% and the sodium content below 0.5 ppm. The phosphorus content is 4.6%.

30 g of crystals of TPP-P*2PhOH occupy a volume of 52 ml.

A proportion of the crystalline TPP-P*2PhOH produced in said manner is weighed out with phenol in a 40:60 molar ratio under an N₂ atmosphere into a 20 ml rolled rim vial with a magnetic stirrer (total quantity 10 g) and sealed with a septum. These vials are clamped in an automatic shaker and immersed in a temperature-controlled water bath. The temperature of the water bath is then raised in steps (5° C./h) until the mixture is in liquid form, while the shaker simultaneously ensures optimum mixing. Once melted, the sample is removed from the water bath and cooled to room temperature. The sample remains liquid; the solidification point is −3° C.

### Example 1

209 g (2.22 mol) of phenol, 79 ml of deionised water and 83.86 g (0.2 mol) of tetraphenylphosphonium bromide are initially introduced into a 2 L round-bottomed flask fitted with a stirrer, thermometer and dropping funnel and stirred at 40° C. 25.64 g (0.30 mol) of 47% sodium hydroxide solution are added dropwise within approx. 5 minutes, the pH value is adjusted to a range from 9.5 to 11.0. The mixture is then stirred for 1 h at 50° C. 160 g of isobutanol are then added. Once the phases have separated, the lower, aqueous phase is drained off and the organic phase washed five times with deionised water, with the washing water as the heavier phase in each case being drained off from beneath. The isobutanol is then removed from the organic phase by vacuum distillation with stirring. The clear, colorless formulation of tetraphenylphosphonium phenolate and phenol, which is liquid at room temperature, is then obtained. According to ³¹P-NMR, the yield is 94%.

The formulation has a TPP-P content of 42.1 wt. % and a phenol content of 57.8 wt. %. The water content is below 0.05%, the bromine content below 0.01% and the sodium content below 0.5 ppm. The phosphorus content is 3.3%.

30 g of the liquid formulation of tetraphenylphosphonium phenolate and phenol occupy a volume of 47 ml.

The solidification point is −4° C.

### Example 2

225.6 g (2.40 mol) of phenol, 105 ml of deionized water and 83.86 g (0.2 mol) of tetraphenylphosphonium bromide are initially introduced into a 2 L round-bottomed flask fitted with a stirrer, thermometer and dropping funnel and stirred at 40° C. 25.64 g (0.30 mol) of 47% sodium hydroxide solution are added dropwise within approx. 5 minutes, the pH value is adjusted to a range from 9.5 to 11.0. The mixture is then stirred for 1 h at 50° C. 160 g of isobutanol are then added. Once the phases have separated, the lower, aqueous phase is drained off and the organic phase washed five times with deionized water, with the washing water as the heavier phase in each case being drained off from beneath. The isobutanol is then removed from the organic phase by vacuum distillation with stirring. The clear, colourless formulation of tetraphenylphosphonium phenolate and phenol, which is liquid at room temperature, is then obtained.

The formulation has a TPP-P content of 37.6 wt. % and a phenol content of 62.3 wt. %. The water content is below 0.05%, the bromine content below 0.01% and the sodium content below 0.5 ppm. The phosphorus content is 2.8%. 30 g of the liquid formulation of tetraphenylphosphonium phenolate and phenol occupy a volume of 51 ml.

### Example 3

282 g (3.00 mol) of phenol, 105 ml of deionized water and 83.86 g (0.2 mol) of tetraphenylphosphonium bromide are initially introduced into a 2 L round-bottomed flask fitted with a stirrer, thermometer and dropping funnel and stirred at 40° C. 25.64 g (0.30 mol) of 47% sodium hydroxide solution are added dropwise within approx. 5 minutes, the pH value is adjusted to a range from 9.5 to 11.0. The mixture is then stirred for 1 h at 50° C. 160 g of isobutanol are then added. Once the phases have separated, the lower, aqueous phase is drained off and the organic phase washed five times with deionized water, with the washing water as the heavier phase in each case being drained off from beneath. The isobutanol is then removed from the organic phase by vacuum distillation with stirring. The clear, colourless formulation of tetraphenylphosphonium phenolate and phenol, which is liquid at room temperature, is then obtained.

The formulation has a TPP-P content of 28.3 wt. % and a phenol content of 71.6 wt. %. The water content is below 0.05%, the bromine content below 0.01% and the sodium content below 0.5 ppm. The phosphorus content is 2.2%.

30 g of the liquid formulation of tetraphenylphosphonium phenolate and phenol occupy a volume of 48 ml.

The solidification point is −21° C.

### Practical Examples

B1) 45.66 g (0.20 mol) of bisphenol A and 46.70 g (0.22 mol) of diphenyl carbonate are weighed out into a 500 ml three-necked flask fitted with a stirrer, internal thermometer and Vigreux column (30 cm, mirrored). Atmospheric oxygen is removed from the apparatus by applying a vacuum and flushing with nitrogen (3 times) and the mixture is heated to 190° C. 0.0082 g (4×10⁻³ mol %) of the liquid formulation of tetraphenylphosphonium phenolate (TPP-P) produced according to Example 1, relative to bisphenol A, are then added and, once the mixture has melted, the resultant phenol is removed by distillation at 100 mbar over a period of 30 minutes. The temperature is then raised to 2350° C. and distillation continued for a further 10 minutes. The vacuum is then improved in steps down to 60 mbar and the temperature raised in 10 minutes to 300° C. In another 10 minutes, the vacuum is adjusted to 0.1 mbar and the mixture stirred for 30 minutes. A light-colored, solvent-free polycarbonate with a relative solution viscosity of 1.215 (dichloromethane, 250° C., 5 g/l) is obtained. The color value of the polycarbonate is 0.25.

B2) 45.66 g (0.20 mol) of bisphenol A and 46.70 g (0.22 mol) of diphenyl carbonate are weighed out into a 500 ml three-necked flask fitted with a stirrer, internal thermometer and Vigreux column (30 cm, mirrored). Atmospheric oxygen is removed from the apparatus by applying a vacuum and flushing with nitrogen (3 times) and the mixture is heated to 190° C. 0.0122 g (4×10⁻¹ mol %) of the liquid formulation of tetraphenylphosphonium phenolate (TPP-P) produced according to Example 3, relative to bisphenol A, are then added and, once the mixture has melted, the resultant phenol is removed by distillation at 100 mbar over a period of 30 minutes. The temperature is then raised to 235° C. and distillation continued for a further 10 minutes. The vacuum is then improved in steps down to 60 mbar and the temperature raised in 10 minutes to 300° C. In another 10 minutes, the vacuum is adjusted to 0.1 mbar and the mixture stirred for 30 minutes. A light-colored, solvent-free polycarbonate with a relative solution viscosity of 1.197 (dichloromethane, 25° C., 5 g/l) is obtained. The color value of the polycarbonate is 0.24.

The Examples clearly demonstrate the surprising superiority of the process according to the invention for the production of a formulation of tetraphenylphosphonium phenolate and phenol which is liquid at room temperature, which process is distinctly simpler than that described in the literature and can be carried out on a large industrial scale. Using the formulation of tetraphenylphosphonium phenolate and phenol which is liquid at room temperature for the production of polycarbonates gives rise to polycarbonates which exhibit a good color value.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A process for producing a high purity tetraphenylphosphonium phenolate that at room temperature is in liquid form comprising
(i) reacting tetraphenylphosphonium halide with phenol in an aqueous-alkaline solution at temperatures of 0 to 55° C., wherein molar ratio of phenol to tetraphenylphosphonium halide is ≧10:1 and at pH values of 9.5 to 11 and,
(ii) upon completion of the reaction of (i) adding thereto alcohol in an amount sufficient to separate the aqueous phase from the organic phase, the weight ratio of aqueous reation solution to alcohol being in the range of 2:1 to 1:2 and wherein the solubility of the alcohol in pure water is <20 wt. %.

2. The process according to claim 1 wherein the alcohol is a member selected from the group consisting of aliphatic alcohols conforming to CₙH₂ₙ₊₁—OH, where n is 4 to 10, cycloaliphatic alcohols conforming to CₙH₂ₙ₋₁—OH, where n is 5 to 10.

3. The process according to claim 2 wherein the alcohol is a member selected from the group consisting of n-propanol, isopropanol, n-butanol, isobutanol, n-pentanol, methylbutanol, neopentanol, amyl alcohol, branched and unbranched hexanol, heptanol, octanol, nonanol decanol, cyclopentanol, methylcyclopentanol, cyclopentanemethanol, cyclopentylpropanol, cyclohexanol, cyclohexylethanol, cyclohexylpropanol, cyclohexylbutanol, methyl butylhexanol, ethyl butylhexanol, propyl butylhexanol and butylhexanol, cycloheptanols, and cyclooctanols.

4. The process of claim 2 wherein the alcohol is selected from the group consisting of propanol, (iso)butanol, pentanol hexanol, cyclopentanol, cycloheptanol and cyclooctanol.

5. The process of claim 1 wherein the alcohol is isobutanol.

6. The phosphonium phenolate prepared by the process of claim 1.

7. The phosphonium phenolate prepared by the process of claim 2.

8. The phosphonium phenolate of claim 6 having a halide content of no more than 0.1 wt. %.

9. The phosphonium phenolate of claim 6 having an alkali metal content of no more than 0.5 ppm.

10. A process of using the phosphonium phenolate of claim 6 comprising catalyzing therewith a transesterification reaction.

11. The process of claim 10 wherein the product of the reaction is a polycarbonate resin.

12. The process of claim 1 wherein the solubility is <15 wt. %.

13. The process of claim 1 wherein the temperature is 15 to 50° C.
